(19) United States
(12) Patent Application Publication
(10) Pub. No.: US 2016/0322814 A1
(43) Pub. Date: Nov. 3, 2016

(54) Waste Heat Recovery System With Current Regulator

(71) Applicant: Tenneco Automotive Operating Company Inc., Lake Forest, IL (US)

(72) Inventor: Borys J. Melnyk, Plymouth, MI (US)

(21) Appl. No.: 14/699,233

(22) Filed: Apr. 29, 2015

(51) Int. Cl. H02J 1/10

(52) U.S. Cl. CPC H02J 1/10

(57) ABSTRACT

A vehicle power generation system may include an alternator and an energy conversion device that supply electrical power to an electrical system of a vehicle. A regulator may control the alternator based on a voltage level of the electrical system. A control module may control the energy conversion device based on an operation indicator of the alternator such that the control module adjusts a field coil current of the energy conversion device based on operation indicator of the alternator.

### FIELD

The present disclosure relates to a waste heat recovery system, and more particularly, to a waste heat recovery system for a vehicle.

### BACKGROUND

This section provides background information related to the present disclosure which is not necessarily prior art.

A waste heat recovery system (e.g., a Rankine cycle system) can be used in a vehicle to absorb heat from a vehicle fluid that carries waste heat (e.g., exhaust gas, compressed engine-intake air, engine coolant, etc.) and convert the heat energy from the fluid into usable energy. For example, a waste heat recovery system can use energy from waste heat to provide power to an electrical generator/alternator to charge batteries, operate electrical accessories of the vehicle, and/or power a motor of the vehicle.

### SUMMARY

This section provides a general summary of the disclosure, and is not a comprehensive disclosure of its full scope or all of its features.

In a feature of the present disclosure, a vehicle power generation system may include: an alternator, a regulator, an energy conversion device, and a control module. The alternator supplies electrical power to an electrical system of a vehicle. The regulator controls the alternator based on a voltage level of the electrical system. The energy conversion device supplies electrical power to the electrical system of the vehicle. The control module controls the energy conversion device based on an operation indicator of the alternator. The control module adjusts a field coil current of the energy conversion device based on the operation indicator of the alternator.

In a feature of the present disclosure, a vehicle power generation system may include an engine driven electrical system and a waste heat recovery system. The engine drive electrical system may include: an alternator and a regulator. The alternator is coupled to an engine of a vehicle. The alternator converts energy from the engine to electrical power and supplies electrical power to an electrical system of the vehicle. The regulator controls a field coil current of the alternator based on a voltage level of the electrical system.

The waste heat recovery system may include: a power source, an energy conversion device, and a control module. The power source converts thermal energy from a fluid to usable energy. The energy conversion device is coupled to the power source and is driven by usable energy from the power source. The energy conversion device converts energy from the power source to electrical power and supplies electrical power to the electrical system of the vehicle. The control module controls an electrical output of the energy conversion device based on the field coil current of the alternator. The control module adjusts a field coil current of the energy conversion device based on the field coil current of the alternator.

In a feature, a method for controlling an energy conversion device of a waste heat recovery system and an alternator of an engine driven electrical system is disclosed. The method includes: detecting a voltage level of an electrical system of the vehicle, where the waste heat recovery system and the engine driven electrical system are operable to supply electrical power to the electrical system; controlling an electrical power output of the alternator based on the voltage level of the electrical system; determining an operation indicator of the alternator, where the operation indicator is a performance parameter of the alternator; and controlling an electrical power output of the energy conversion device based on the operation indicator of the alternator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic representation of an electrical power system of a vehicle that includes an engine driven electrical system and a waste heat recovery system;

FIG. 2 is a functional block diagram of a regulator of the engine driven electrical system;

FIG. 3 is a functional block diagram of a waste heat recovery control module of the waste heat recovery system;

FIG. 4 is an example control routine performed by the waste heat recovery control module; and

FIG. 5 is an example energy conversion device control routine performed by the waste heat recovery control module.

Corresponding reference numerals indicate corresponding parts throughout the several views of the drawings.

### DETAILED DESCRIPTION

A vehicle may include an electrical power system that supplies power to various components disposed in the vehicle. The electrical power system may include an engine driven electrical system that generates electrical power using the energy from an internal combustion engine. In addition to the engine driven electrical system, some electrical power systems also include a waste heat recovery (WHR) system that may generate electricity using the thermal energy from a heated source. By adding the WHR system, a control scheme is needed to adjust the electrical power outputs of the engine driven electrical system and of the WHR system to ensure optimal power is being supplied to the electrical power system of the vehicle.

More particularly, a control scheme of the present disclosure controls a WHR system based on the operation of the engine driven electrical system. Accordingly, the WHR system may be considered a supplemental power system for supporting the engine driven electrical system such that the engine driven electrical system may control the overall voltage level of the system and the WHR system may indirectly control the engine driven electrical system.

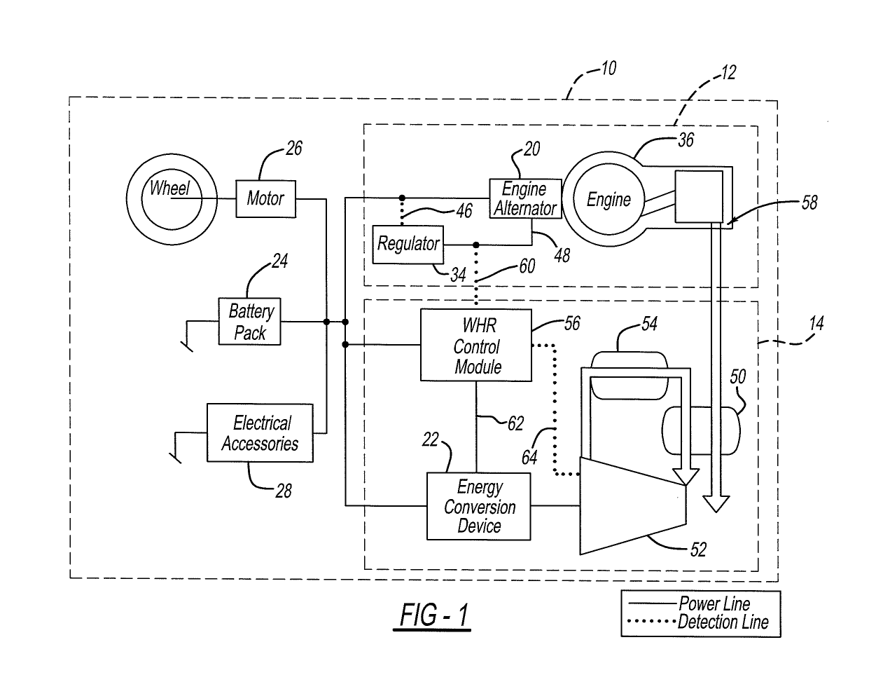

The present disclosure will now be described more fully with reference to the accompanying drawings. Referring to FIG. 1, an electrical power system 10 for a vehicle may include an engine driven electrical system 12 and a waste heat recovery (WHR) system 14, which are collectively referred to as power generation systems 12 and 14. The power generation systems 12 and 14 generate electrical power by converting one form of energy (e.g. mechanical, thermal) to electrical energy by way of an alternator 20 and an energy conversion device 22, respectively. The electrical power generated from the power generation systems 12 and 14 may be supplied to other components in the vehicle by way of an electrical network. As an example, the electrical power from the power generation systems 12 and 14 may be used to charge one or more batteries in a battery pack 24, to operate a motor 26, and/or to power electrical accessories 28.

The engine driven electrical system 12 includes the engine alternator 20 (i.e., “engine alternator” hereinafter) and a regulator 34. The engine alternator 20 is coupled to an internal combustion engine 36 of the vehicle such that the engine alternator 20 converts mechanical energy from the engine 36 to electrical power (e.g., direct current). Accordingly, when the engine 36 is in operation, the engine alternator 20 is capable of supplying electrical power to the electrical power system 10 of the vehicle.

The regulator 34 controls the engine alternator 20 based on the amount of voltage being supplied in electrical power system 10. More particularly, the regulator 34 may compare the actual voltage of the electrical power system 10 to a system voltage threshold. If the actual voltage is above the system voltage threshold (e.g., 12V, 24V), the regulator 34 may reduce the power being output by the engine alternator 20. Alternatively, if the actual voltage is below the system voltage threshold, the regulator 34 may increase the power being output by the engine alternator 20 in order to meet the demand of the electrical power system 10.

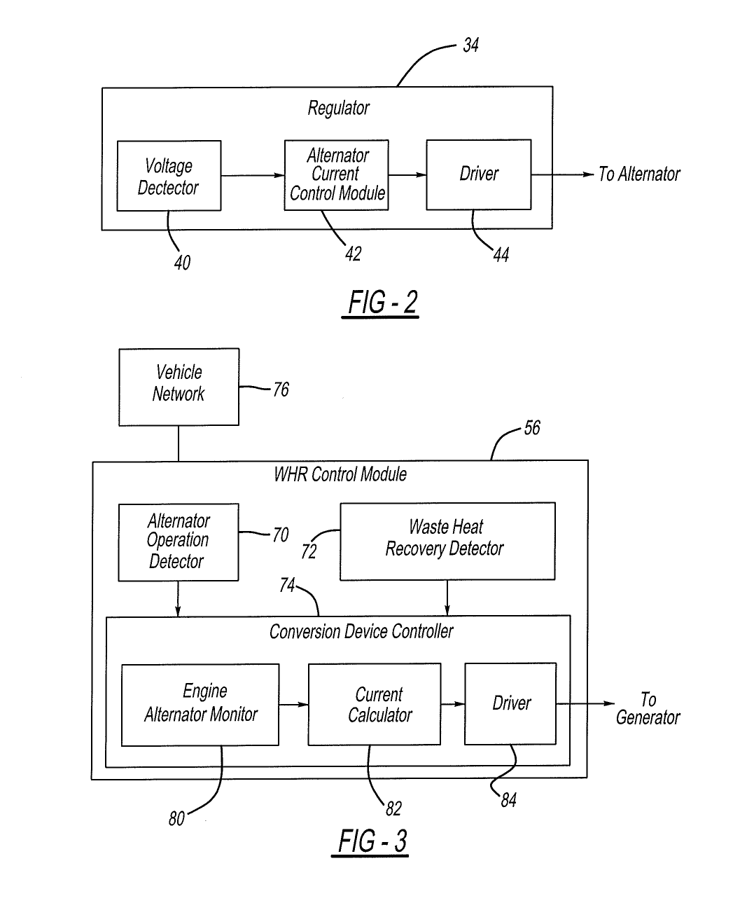

Referring to FIG. 2, the regulator 34 includes a voltage detector 40, an alternator current control module 42, and a driver 44. The voltage detector 40 monitors the amount of voltage being supplied to the electrical power system 10. As an example, the voltage detector 40 may be a sensor that detects the voltage at an output of the engine alternator 20, as illustrated by detection line 46 in FIG. 1.

Based on the voltage detected, the regulator 34 controls the performance of the engine alternator 20 by adjusting a field coil current of the engine alternator 20. Specifically, the field coil current of the engine alternator 20 affects the strength of the magnetic field inside the engine alternator 20, thereby adjusting the output of the engine alternator 20. The alternator current control module 42 calculates the field coil current using pre-stored algorithms that gradually adjust the field coil current based on the voltage of the electrical power system 10 and other factors such as engine speed, maximum current threshold of the engine alternator 20, and/or other suitable factors.

The regulator 34 applies the calculated field coil current to the engine alternator 20, as illustrated by line 48 in FIG. 1. More particularly, the driver 44 of the regulator 34 outputs an electrical current to the engine alternator 20. While the engine alternator 20 and the regulator 34 are shown as separate components in FIG. 1, the engine alternator 20 and the regulator 34 may be provided together as a single component referred to as an alternator regulator. The regulator may also be implemented as part of a control module.

Referring to FIG. 1, the WHR system 14 includes an evaporator 50, an expander 52, a condenser 54, the energy conversion device 22, and a WHR control module 56. The WHR system 14 may be a Rankine cycle waste heat recovery system that receives fluid, such as exhaust gas, from a source 58. In the example embodiment, the source 58 is an engine exhaust system that supplies hot exhaust gas to the WHR system 14. Alternatively, the source 58 may be an exhaust gas recirculation system, an engine air induction system, an engine coolant circuit, or other suitable system within the vehicle that supplies a heated fluid to the WHR system 14. In addition, based on the source 58, the fluid supplied to the WHR system 14 is not limited to exhaust gas and may include, for example, engine coolant, compressed air, charged air from a turbo charger, recirculated exhaust gas, and/or other heated fluid.

The evaporator 50, the expander 52, and the condenser 54 convert the thermal energy from the exhaust gas to usable energy, such as mechanical energy, and may be considered part of a power source that drives the energy conversion device 22. By way of explanation, the evaporator 50 receives fluid from the source 58. Working fluid flowing through the evaporator 50 absorbs heat from the fluid received. That is, working fluid flowing through the evaporator 50 is heated by the fluid from the source 58.

Working fluid from the evaporator 50 flows to the expander 52 to power an output shaft of the expander 52. The output shaft of the expander 52 may be connected to the energy conversion device 22 to drive the energy conversion device 22. Working fluid may flow from the expander 52 to the condenser 54. Heat from the working fluid may be transferred to ambient air flowing through the condenser 54 and/or coolant that flows through a conduit in the condenser 54. Cooled working fluid exiting the condenser 54 may be returned to the evaporator 50, where it is heated again by fluid from the source 58.

The energy conversion device 22 converts the energy from the expander 52 to electrical power and supplies the electrical power to the electrical power system 10 of the vehicle. The energy conversion device 22 may include a generator or an alternator. The energy conversion device 22 may perform as a supplemental electrical power source to the engine alternator 20. More particularly, the energy conversion device 22 is controlled to reduce the operation load placed on the engine alternator 20, as described further below.

The WHR control module 56 controls the electrical power output of the energy conversion device 22 based on the operation of the engine alternator 20. Specifically, the WHR control module 56 calculates a field coil current of the energy conversion device 22 based on an operation indicator of the engine alternator 20. For example, the operation indicator of the engine alternator 20 may include the amount of field coil current being applied to the engine alternator, the duty cycle of the field coil current, the index value of the field coil current, a voltage output of the engine alternator 20, and/or other parameter that reflects the performance of the engine alternator 20. The WHR control module 56 may monitor the operation indicator of the engine alternator 20 and control the energy conversion device 22 such that the operation indicator of the engine alternator 20 is maintained at a predefined operation threshold.

By way of example, the operation indicator in the example embodiment is provided as a characteristic of the field coil current applied to the engine alternator 20. For example, the WHR control module 56 may monitor the field coil current being applied to the engine alternator 20, (as illustrated by line 60 in FIG. 1) and determine a field coil current of the energy conversion device 22 such that the field coil current of the engine alternator 20 is maintained at or substantially at a predefined current threshold. The WHR control module 56 may then apply the field coil current to the energy conversion device 22 (as illustrated by line 62 in FIG. 1).

Referring to FIG. 3, the WHR control module 56 includes an alternator operation detector 70, a waste heat recovery detector 72, and a conversion device controller 74. The alternator operation detector 70 determines the operation indicator of the engine alternator 20 based on data from sensors and/or from other modules in the vehicle. As an example, the alternator operation detector 70 determines the amount of field coil current being applied by the regulator 34 to the engine alternator 20 as the operation indicator. The alternator operation detector 70 may include a current sensor, a voltage sensor with predefined algorithms for converting the voltage to current, and/or other suitable mechanism for detecting the current being supplied to the engine alternator 20. Alternatively, the alternator operation detector 70 may receive data representative of the field coil current of the engine alternator 20 from another module (e.g., engine control module) by way of a vehicle network 76, such as CAN or LIN.

The waste heat recovery detector 72 may monitor the performance of the WHR system 14 to determine if the WHR system 14 is operating to convert the thermal energy from the source 58 to usable energy at the expander 52 in order to drive the energy conversion device 22. Specifically, the WHR control module 56 controls the energy conversion device 22 so that the energy conversion device 22 is in an OFF-state (i.e., deactivated) when the WHR system 14 is not operating. As an example, FIG. 1 illustrates a detection line 64 between the WHR control module 56 and the expander 52. The waste heat recovery detector 72 may receive data reflective of the movement of the output shaft of the expander 52 from of one or more sensors disposed at the expander 52. Based on the data received, the waste heat recovery detector 72 may determine if the WHR system 14 is ON or OFF.

The waste heat recovery detector 72 may receive data from other vehicle modules, such as the engine control module, via the vehicle network 76. The engine control module may provide data reflective of the heat of the fluid from the source 58, the amount of fluid entering the WHR system 14, and/or other suitable data used to determine the performance of the WHR system 14.

Based on the data from the alternator operation detector 70 and the waste heat recovery detector 72, the conversion device controller 74 controls the operation of the energy conversion device 22 so that the energy conversion device 22 outputs a desired amount of electrical power to the electrical power system 10. The conversion device controller 74 includes an engine alternator monitor 80, a current calculator 82, and a driver 84.

The engine alternator monitor 80 determines whether the engine alternator 20 is performing over or below a predefined threshold. More particularly, the engine alternator monitor 80 determines whether the operation indicator of the engine alternator 20 is equal to a predefined operation threshold. For example, in the example embodiment, the engine alternator monitor 80 determines whether the field coil current determined by the alternator operation detector 70 is equal to a current threshold. Alternatively, the engine alternator monitor 80 may compare the field coil current to a predefined operation band that includes an operation threshold (e.g., 0.1-2 Amps) with an upper limit and a lower limit (e.g., ±0.01, ±0.02, etc). Accordingly, the operation band may be configured to have first threshold (e.g., the operation threshold−lower limit) and a second threshold (e.g., the operation threshold+upper limit).

The operation threshold is predetermined and stored in a memory of the WHR control module 56. The operation threshold may be set based on a minimum performance output desired from the engine alternator 20. More particularly, with the engine 36 operating, the engine alternator 20 may be configured to continuously generate electrical power. The amount of electrical power generated by the engine alternator 20 may be controlled by the WHR control module 56 by maintaining the operation indicator of the engine alternator 20 at the operation threshold. For example, the WHR control module may maintain the field coil current being applied to the engine alternator 20 to or substantially at the current threshold.

The current calculator 82 determines the field coil current to be applied to the energy conversion device 22 and the driver 84 applies the field coil current to the energy conversion device 22. In the example embodiment, with the expander 52 operating, the current calculator 82 controls the field coil current of the energy conversion device 22 based on the field coil current of the engine alternator 20. More particularly, if the field coil current of the engine alternator 20 is below the current threshold, the current calculator 82 may reduce the field coil current of the energy conversion device 22. By reducing the field coil current, the amount of electrical power supplied by the energy conversion device 22 to the electrical power system 10 decreases. Accordingly, the regulator 34 may detect a drop in voltage in the electrical power system 10, and may increase the field coil current to the engine alternator 20 to maintain the electrical power system 10 at the system voltage threshold.

Conversely, if the field coil current of the engine alternator 20 is greater than the current threshold, the current calculator 82 may increase the field coil current to the energy conversion device 22. By increasing the field coil current, the amount of power supplied by the energy conversion device 22 to the electrical power system 10 increases. The regulator 34 may detect the increase in voltage in the electrical power system 10, and may decrease the field coil current to the engine alternator 20 to maintain the electrical power system at the system voltage threshold. Accordingly, the field coil current to the engine alternator 20 may be controlled at the current threshold by the WHR control module 56 and the amount of power supplied to the electrical power system 10 may be controlled by the regulator 34.

In the example embodiment, the operation indicator of the engine alternator includes the amount of field coil current being supplied to the engine alternator 20. Alternatively, the operation indicator may include the duty cycle of the field coil current, the index value of the field coil current, a voltage output of the engine alternator 20, and/or other parameter that reflects the performance of the engine alternator 20. Thus, based on data from sensors and/or data from other modules, the alternator operation detector 70 determines the operation indicator of the engine alternator 20 and the conversion device controller 74 controls the field coil current of the energy conversion device 22 based on the operation indicator determined and the predefined operation threshold.

As an example, if the operation indicator includes a voltage amount being outputted by the engine alternator 20, the alternator operation detector 70 may determine the voltage amount based on the field coil current being supplied to the engine alternator 20 and/or data from other modules. In addition, the conversion device controller 74 may increase the field coil current applied to the energy conversion device 22 when the voltage amount is greater than a predefined voltage threshold (i.e., the operation threshold) and may decrease the field coil current applied to the energy conversion device 22 when the voltage amount is less than the predefined voltage threshold.

Using pre-stored control algorithms and calibration data, the current calculator 82 determines the field coil current of the energy conversion device 22 without causing quick voltage changes within the electrical power system 10. In addition, the current calculator 82 controls the field coil current of the energy conversion device 22 based on a maximum current limit of the energy conversion device 22 such that the field coil current of the energy conversion device 22 is maintained below the maximum current limit.

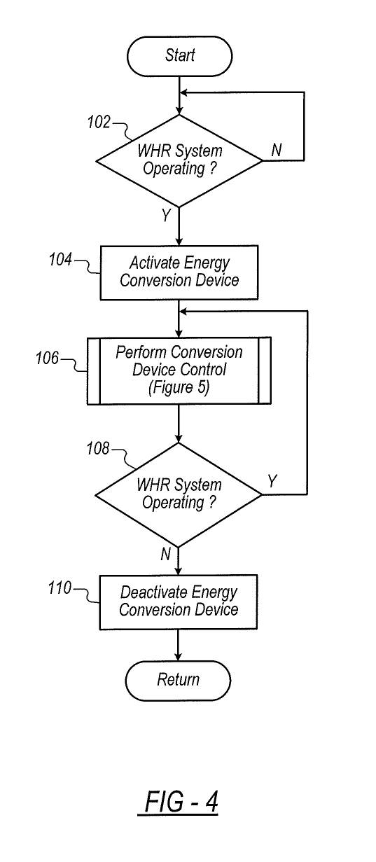

Referring to FIG. 4, an example control routine performed by the WHR control module 56 is shown. The WHR control module 56 may perform the routine of FIG. 4 when it receives power from the electrical power system 10. At 102, the routine determines whether the WHR system 14 is operating. As an example, the WHR control module 56 may monitor the expander 52 to determine if thermal energy from the source 58 is being converted to drive the energy conversion device 22. If the WHR system 14 is not operating, the routine returns to 102. If the WHR system is operating, the routine may activate the energy conversion device 22 at 104 by, for example, supplying power to the energy conversion device 22.

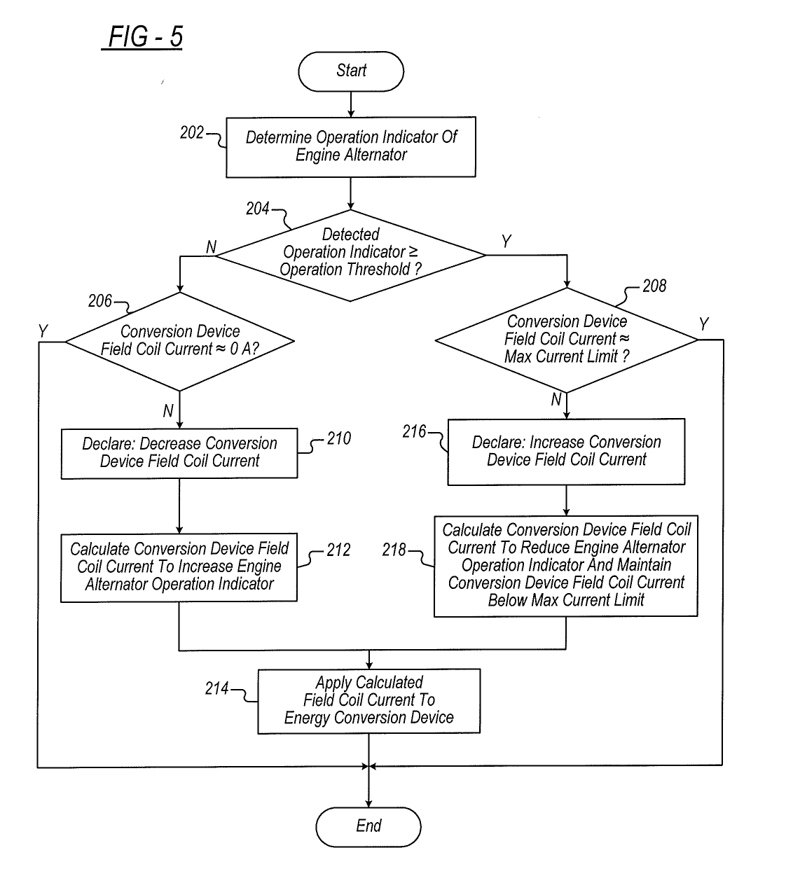

At 106, the routine performs a conversion device control routine, which is described in detail with reference to FIG. 5. At 108, the routine determines if the WHR system 14 is operating. Here, the routine monitors the output of the WHR system 14 to ensure that the expander 52 is driving the energy conversion device 22. If the WHR system is operating, the routine returns to 106. If the WHR system 14 is not operating, the routine deactivates the energy conversion device 22 at 110 and returns to the beginning of the routine. To deactivate the energy conversion device 22, the WHR control module 56 may gradually decrease the field coil current applied of the energy conversion device 22 before turning off the energy conversion device 22, or the WHR control module 56 may gradually decrease the field coil current of the energy conversion device 22 until it is approximately zero but maintain power to the energy conversion device 22 until the WHR control module 56 no longer receives power from the electrical power system 10.

With reference to FIG. 5, an example conversion device control routine performed by the WHR control module 56 is shown. The WHR control module 56 performs the routine of FIG. 5 at 106 of FIG. 4. At 202, the routine determines the operation indicator of the engine alternator 20. For example, if the operation indicator includes the field coil current, the WHR control module 56 may detect the amount of field coil current being applied to the engine alternator 20. At 204, the routine determines whether the determined operation indicator is greater than or equal to an operation threshold. If the detected operation threshold is less than the operation threshold, the routine proceeds to 206. If the operation indicator is greater than or equal to the operation threshold, the routine proceeds to 208.

At 206, the routine determines whether the field coil current of the energy conversion device 22 is equal to zero amps. With the operation indicator of the engine alternator 20 below the operation threshold, the field coil current of the energy conversion device 22 may be reduced in order to increase the performance output of the engine alternator 20. For example, by decreasing the field coil current of the energy conversion device 22, the regulator 46 may increase the field coil current of the engine alternator 20. If the field coil current of the energy conversion device 22 is zero, then the routine ends since the field coil current of the energy conversion device 22 cannot be reduced any further. If the field coil current of the energy conversion device 22 is not zero, at 210 the routine declares that the field coil current of the energy conversion device 22 is to be reduced. At 212 the routine calculates the field coil current of the energy conversion device 22 such that the operation indicator of the engine alternator 20 increases. The calculated field coil current is applied to the energy conversion device at 214.

At 208, the routine determines whether the field coil current of the energy conversion device 22 is equal to a maximum current limit. If the field coil current is equal to the maximum current limit, the routine ends because the energy conversion device 22 is operating at its maximum current limit. If the field coil current is not equal to the maximum current limit, the routine at 216 declares that the field coil current of the energy conversion device 22 is to be increased in order to reduce performance output of the engine alternator 20. For example, by increasing the field coil current of the energy conversion device 22, the regulator 46 may reduce the field coil current of the engine alternator 20 such that the amount of power being outputted by the engine alternator 20 decreases. At 218 the routine calculates the field coil current of the energy conversion device 22, such that the operation indicator of the engine alternator 20 reduces while maintaining the field coil current of the energy conversion device 22 below the maximum current limit. The calculated field coil current is applied to the energy conversion device at 214.

The WHR system 14 may reduce the electrical load placed on the engine alternator 20 by supplementing electrical power to the electrical power system 10 of the vehicle. By reducing the output of the engine alternator 20, the amount of fuel used to drive the engine alternator 20 may be reduced. More particularly, while fuel may be used to create the exhaust needed for the WHR system 14, the amount of fuel used to drive the energy conversion device 22 may be less than the amount of fuel needed to drive the engine alternator 20, thereby potentially improving fuel efficiency of the vehicle.

Furthermore, by having the WHR system 14, the electrical power system 10 of the vehicle does not require a reconfiguration of a voltage control scheme performed by the regulator 34 of the engine driven electrical system 12. Specifically, the engine driven electrical system 12 continues to supply the necessary electrical power to meet the demand of the system by simply monitoring the voltage level of the electrical power system 10 irrespective of the operation of the WHR system 14. Thus, WHR system 14 can be implemented with a standard engine driven electrical system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, operations, elements, and/or components, but do not preclude the presence or addition of one or more other features, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

In this application, including the definitions below, the term ‘module’ or the term ‘controller’ may be replaced with the term ‘circuit.’ The term ‘module’ may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

What is claimed is:

1. A vehicle power generation system comprising:
an alternator supplying electrical power to an electrical system of a vehicle;
a regulator controlling the alternator based on a voltage level of the electrical system;
an energy conversion device supplying electrical power to the electrical system of the vehicle; and
a control module controlling the energy conversion device based on an operation indicator of the alternator, wherein the operation indicator is a performance parameter of the alternator, the control module adjusts a field coil current of the energy conversion device based on the operation indicator of the alternator.

2. The vehicle power generation system of claim 1 wherein:
the control module decreases the field coil current of the energy conversion device when the operation indicator of the alternator is below an operation threshold, and
the control module increases the field coil current of the energy conversion device when the operation indicator of the alternator is above the operation threshold.

3. The vehicle power generation system of claim 1 wherein:
the control module decreases the field coil current of the energy conversion device when the operation indicator of the alternator is less than or equal to a first threshold, and
the control module increases the field coil current of the energy conversion device when the operation indicator of the alternator is greater than or equal to a second threshold is greater than the first threshold.

4. The vehicle power generation system of claim 1 further comprising:
a waste heat recovery system including the energy conversion device and the control module.

5. The vehicle power generation system of claim 1 wherein the control module maintains the field coil current of the energy conversion device below a maximum current limit.

6. The vehicle power generation system of claim 1 wherein:
the regulator increases the field coil current of the alternator when the voltage level of the electrical system is less than a voltage threshold,
the regulator decreases the field coil current of the alternator when the voltage of the electrical system is greater than the voltage threshold,
the control module decreases the field coil current of the energy conversion device when the operation indicator of the alternator is below an operation threshold, and
the control module increases the field coil current of the energy conversion device when the operation indicator of the alternator is above the operation threshold.

7. The vehicle power generation system of claim 1 wherein the energy conversion device is an alternator.

8. The vehicle power generation system of claim 1 wherein the energy conversion device is a generator.

9. The vehicle power generation system of claim 1 wherein:
the regulator controls a field coil current of the alternator to control an electrical output of the alternator, and
the operation indicator includes the field coil current of the alternator such that the control module controls the energy conversion device based on the field coil current of the alternator.

10. The vehicle power generation system of claim 1 wherein the operation indicator includes a voltage amount being output by the alternator such that the control module controls the energy conversion device based on the voltage amount of the alternator.

11. A vehicle power generation system comprising:
an engine driven electrical system comprising:
an alternator being coupled to an internal combustion engine of a vehicle, wherein the alternator converts energy from the engine to electrical power and supplies electrical power to an electrical system of the vehicle, and
a regulator controlling the alternator based on a voltage level of the electrical system, wherein the regulator controls a field coil current of the alternator; and
a waste heat recovery system comprising:
a power source converting thermal energy from a fluid to usable energy,
an energy conversion device coupled to the power source and being driven by usable energy from the power source, wherein the energy conversion device converts energy from the power source to electrical power and supplies electrical power to the electrical system of the vehicle, and
a control module controlling an electrical output of the energy conversion device based on the field coil current of the alternator, wherein the control module adjusts a field coil current of the energy conversion device based on the field coil current of the alternator.

12. The vehicle power generation system of claim 11 wherein the waste heat recovery system is a Rankine cycle system.

13. The vehicle power generation system of claim 11 wherein the power source of the waste heat recover system includes:
an evaporator that receives fluid from a source, wherein working fluid flowing in the evaporator absorbs heat from the fluid, and
an expander disposed downstream of the evaporator and connected to the energy conversion device, wherein the expander receives the working fluid from the evaporator and drives the energy conversion device.

14. The vehicle power generation system of claim 11 wherein:
the control module decreases the field coil current of the energy conversion device when the field coil current of the alternator is below an operation threshold, and
the control module increases the field coil current of the energy conversion device when the field coil current of the alternator is above the operation threshold.

15. The vehicle power generation system of claim 11 wherein the control module determines the field coil current of the alternator based on data from one or more modules disposed in the vehicle.

16. The vehicle power generation system of claim 11 wherein:
the regulator increases the field coil current of the alternator when the voltage level of the electrical system is less than a voltage threshold,
the regulator decreases the field coil current of the alternator when the voltage of the electrical system is greater than the voltage threshold,
the control module decreases the field coil current of the energy conversion device when the field coil current of the alternator is below an operation threshold, and
the control module increases the field coil current of the energy conversion device when the field coil current of the alternator is above the operation threshold.

17. The vehicle power generation system of claim 11 wherein the energy conversion device is an alternator.

18. The vehicle power generation system of claim 11 wherein the energy conversion device is a generator.

19. The vehicle power generation system of claim 11 wherein the control module controls the field coil current of the energy conversion device based on at least one of an amount of the field coil current of the alternator or a duty cycle of the field coil current of the alternator.

20. A method for controlling an energy conversion device of a waste heat recovery system and an alternator of an engine driven electrical system, the waste heat recovery system and the engine driven electrical system are disposed in a vehicle, the method comprising:
detecting a voltage level of an electrical system of the vehicle, wherein the waste heat recovery system and the engine driven electrical system are operable to supply electrical power to the electrical system;
controlling an electrical power output of the alternator based on the voltage level of the electrical system;
determining an operation indicator of the alternator, wherein the operation indicator is a performance parameter of the alternator; and
controlling an electrical power output of the energy conversion device based on the operation indicator of the alternator.

21. The method of claim 20 further comprising:
determining whether the voltage level of the electrical system is equal to a voltage system threshold;
decreasing a field coil current of the alternator in response to the voltage level being greater than the voltage system threshold; and
increasing the field coil current of the alternator in response to the voltage level being less than the voltage system threshold.

22. The method of claim 20 further comprising:
determining whether the operation indicator of the alternator is equal to an operation threshold;
decreasing a field coil current of the energy conversion device in response to the operation indicator of the alternator being less than the operation threshold; and
increasing the field coil current of the energy conversion device in response to the operation indicator being greater than the operation threshold.

23. The method of claim 20 further comprising:
comparing the operation indicator of the alternator to a first threshold and a second threshold greater than the first threshold;
decreasing a field coil current of the energy conversion device in response to the operation indicator of the alternator being less than or equal to the first threshold, and
increasing the field coil current of the energy conversion device in response to the operation indicator of the alternator being greater than or equal to the second threshold.

24. The method of claim 20 further comprising:
determining whether the voltage level of the electrical system is equal to a voltage system threshold;
decreasing a field coil current of the alternator in response to the voltage level being greater than the voltage system threshold;
increasing the field coil current of the alternator in response to the voltage level being less than the voltage system threshold;
determining whether the operation indicator of the alternator is equal to an operation threshold;
decreasing a field coil current of the energy conversion device in response to the operation indicator of the alternator being less than the operation threshold; and
increasing the field coil current of the energy conversion device in response to the operation indicator being greater than the operation threshold.

25. The method of claim 20 wherein the operation indicator includes a characteristic of a field coil current being applied to the alternator and the method further comprises:
determining whether a field coil current being applied to the alternator is equal to an operation threshold;
decreasing a field coil current of the energy conversion device in response to the field coil current of the alternator being less than the operation threshold; and
increasing the field coil current of the energy conversion device in response to the field coil current being greater than the operation threshold.

26. The method of claim 20 wherein the operation indicator includes a voltage amount being outputted by the alternator to the electrical system and the method further comprises:
determining whether the voltage amount of the alternator is equal to an operation threshold;
decreasing a field coil current of the energy conversion device in response to the voltage amount of the alternator being less than the operation threshold; and
increasing the field coil current of the energy conversion device in response to the voltage amount being greater than the operation threshold.
